(19) United States
(12) Patent Application Publication
(10) Pub. No.: US 2024/0273590 A1
(43) Pub. Date: Aug. 15, 2024

(54) SYSTEMS AND METHODS FOR AUTOMATIC LEAD GENERATION AND MESSAGING USING ARTIFICIAL INTELLIGENCE

(71) Applicant: Allstate Insurance Company, Northbrook, IL (US)

(72) Inventors: Gaurav Atwal, Novi, MI (US); Michael He, North Reading, MA (US); Michael Watson, Delaware, OH (US); Austin Smith, Southgate, MI (US); Cameron Devitt, Charlotte, NC (US); Stephanie Graham, Roanoke, VI (US); Merle Flakes, Prosper, TX (US); Corinne Scott, Rocklin, CA (US)

(21) Appl. No.: 18/437,349

(22) Filed: Feb. 9, 2024

Related U.S. Application Data
(60) Provisional application No. 63/444,262, filed on Feb. 9, 2023.

(51) Int. Cl. G06Q 30/0601; G06F 3/04842; G06K 19/06; G06Q 40/08; H04L 9/40; H04M 1/72436; H04W 4/14

(52) U.S. Cl. CPC G06Q 30/0611; G06F 3/04842; G06K 19/06037; G06Q 40/08; H04L 63/0861; H04L 63/102; H04M 1/72436; H04W 4/14

(57) ABSTRACT

Systems and methods for messaging a user include one or more processors, one or more memory components, and machine readable instructions that cause the AI system to perform at least the following when executed by the one or more processors: request a consent input from a user, receive the consent input from the user, send a message to a mobile device of the user, responsive to the user selecting an option of being connected to the agent, and responsive to the user not selecting the option of being connected to the agent, and send one or more further messages presenting the user with the option of being connected to the agent on a pre-determined schedule until (i) a pre-determined duration of time expires or (ii) the user selects the option of being connected to the agent within the pre-determined duration of time.

### CROSS REFERENCE TO RELATED APPLICATIONS

The present application claims priority to U.S. Provisional Patent Application No. 63/444,262, filed Feb. 9, 2024, and entitled “SYSTEMS AND METHODS FOR AUTOMATIC LEAD GENERATION AND MESSAGING USING ARTIFICIAL INTELLIGENCE,” the entirety of which is incorporated by reference herein.

### TECHNICAL FIELD

The present disclosure relates to AI systems and methods, and, in particular, AI systems and methods including an AI system to obtain user consent to connect users to agents to thereafter automatically connect users to agents based on at least user profiles.

### BACKGROUND

Lead routing systems may operate through a lead contacting a call center and a system routing the lead to a particular agent or department associated with the call center. For example, a lead may call a call center of a vendor after being exposed to an advertisement, and the lead may be routed to the correct agent or department of the vendor. A need exists for more efficient and streamlined lead generation and routing of the lead to appropriate personnel such as representative agents of a vendor for discussion of sales and/or services.

### SUMMARY

Aspects of the present disclosure relate to lead generated, messaging, and routing. In particular, aspects of the disclosure relate to routing a lead to an agent via messaging through artificial intelligence.

In some instances, a lead may desire to purchase an additional product or service while at a referral location when the referral location is not able to offer the lead the additional product or service. For example, a lead may wish to purchase product insurance when buying a home, boat, or car at the referral location. However, the referral location where the lead is located may not be able to sell or be licensed to sell the desired product insurance. The systems and methods described herein direct the lead to provide consent for artificial-intelligence (AI) based messaging to contact the lead and automatically direct the lead to an appropriate representative to, for example, discuss purchase of the desired sales and/or service, such as the desired product insurance.

According to the subject matter of the present disclosure, an Artificial Intelligence (AI) system may include one or more processors, one or more memory components communicatively coupled to the one or more processors, and machine readable instructions stored in the one or more memory components that cause the AI system to perform at least the following when executed by the one or more processors: request a consent input from a user indicative of consent by the user to be contacted regarding a product or service offer for a property through a consent request page of a digital selection form, receive the consent input from the user on the consent request page of the digital selection form, responsive to receiving the consent input, determine whether the user is associated with a lead profile, responsive to determining the user is not associated with a lead profile for the user, generate a lead profile for the user including data associated with the user and the consent input, send a message to a mobile device of the user, wherein the message presents the user with an option of being connected to an agent to discuss the product or service offer for the property, responsive to the user selecting the option of being connected to the agent, route the user to the agent based on the lead profile, and responsive to the user not selecting the option of being connected to the agent, send one or more further messages presenting the user with the option of being connected to the agent on a pre-determined schedule until (i) a pre-determined duration of time expires or (ii) the user selects the option of being connected to the agent within the pre-determined duration of time.

According to another embodiment of the present disclosure, an artificially intelligent computer implemented method may include requesting a consent input from a user indicative of consent by the user to be contacted regarding a product or service offer for a property through a consent request page of a digital selection form, receiving the consent input from the user on the consent request page of the digital selection form, responsive to receiving the consent input, determining whether the user is associated with a lead profile, and responsive to determining the user is not associated with a lead profile for the user, generating a lead profile for the user including data associated with the user and the consent input. The method may further include sending a message to a mobile device of the user, wherein the message presents the user with an option of being connected to an agent to discuss the product or service offer for the property, responsive to the user selecting the option of being connected to the agent, routing the user to the agent based on the lead profile, and responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.

According to yet another embodiment of the present disclosure, an artificially intelligent computer implemented method may include requesting a consent input from a user when the user is at a referral location associated with a property, the consent input indicative of consent by the user to be contacted regarding a product or service offer for the property through a consent request page of a digital selection form displayed on a mobile device of the user, via one or more of interactive communication or non-interactive communication with the mobile device of the user, receiving the consent input from the user on the consent request page of the digital selection form, responsive to receiving the consent input, determining whether the user is associated with a lead profile, and responsive to determining the user is not associated with a lead profile for the user, generating a lead profile for the user including data associated with the user and the consent input. The method may further include sending a message to a mobile device of the user, wherein the message presents the user with an option of being connected to an agent to discuss the product or service offer for the property, responsive to the user selecting the option of being connected to the agent, routing the user to the agent based on the lead profile, and responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.

Although the concepts of the present disclosure are described herein with primary reference to an AI consent, messaging, and routing system for integration into insurance policies/businesses, it is contemplated that the concepts will enjoy applicability to any setting for purposes of AI consent, messaging, and routing systems.

### BRIEF DESCRIPTION OF THE DRAWINGS

The present disclosure is illustrated by way of example and not limited in the accompanying figures in which like reference numerals indicate similar elements and in which:

FIG. 1 schematically depicts a flowchart of a method of generating an lead and sending automated AI messaging to the lead, according to one or more embodiments shown and described herein;

FIG. 2 schematically depicts a flowchart of additional process features incorporating the method of FIG. 1; and

FIG. 3 schematically depicts a system for implementing computer and software based methods as set forth in FIG. 1 and/or 2 to generate leads and send automated AI messaging to the generated leads, according to one or more embodiments shown and described herein.

### DETAILED DESCRIPTION:

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

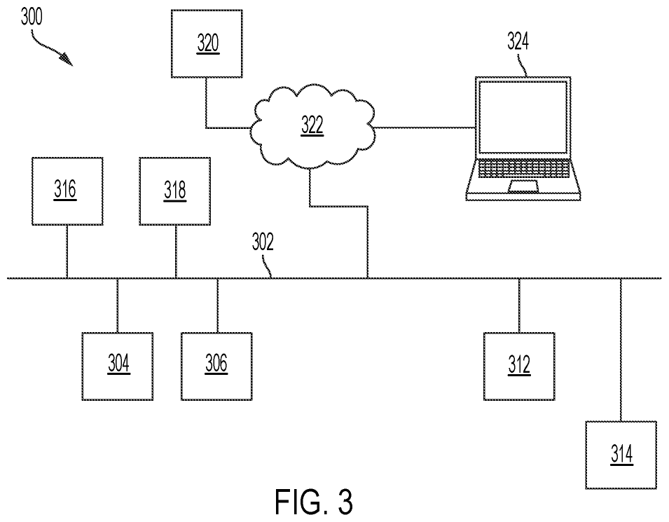

In embodiments described herein, an artificial intelligence (AI) messaging system such as the system 300 of FIG. 3 described in greater detail further below may be used at a referral location, such as at a vendor, retail, or dealership site, to generate a lead and obtain lead consent for automated messaging and to route the lead to an appropriate representative to discuss additional sales and/or services. The AI messaging system may utilize one or more artificial neural network (ANN) models as understood to those skilled in the art or as yet-to-be-developed to generate communications and alerts as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

As an example and not a limitation, a machine learning module of the ANN may include artificial intelligence components selected from the group consisting of an artificial intelligence engine, Bayesian inference engine, and a decision-making engine, and may have an adaptive learning engine further comprising a deep neural network learning engine. Data stored and manipulated in the AI messaging system as described herein is utilized by the machine learning module, which in embodiments able to leverage a cloud computing-based network configuration such as the cloud to apply machine learning and artificial intelligence or may be able to rely on an internal architecture to apply machine learning and artificial intelligence as described herein. This machine learning application may create models that can be applied by the intelligent machine learning to make it more efficient and intelligent in execution.

As discussed hereinabove, the referral location may be a location at which people wait for a service and/or sale, such as a car dealership, bank, boat dealership, mortgage broker, doctor's/dentist's office, urgent care, bus stop, or any other suitable location. The referral location may also be included on written documents, such as written advertisement or other communications, including but not limited to business cards, mailers, flyers, newspapers, or any other suitable written document.

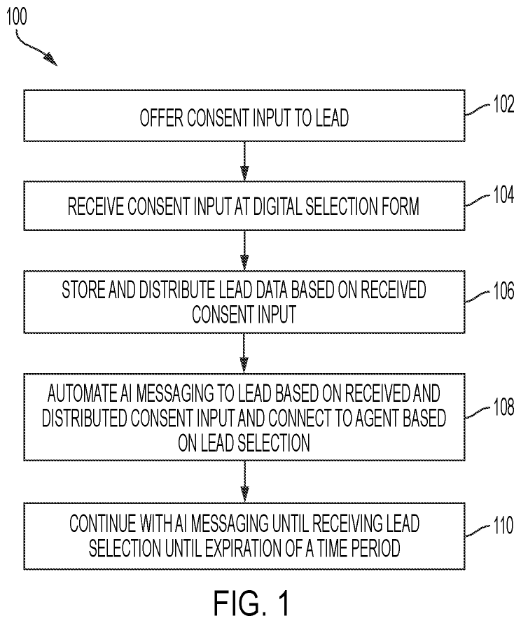

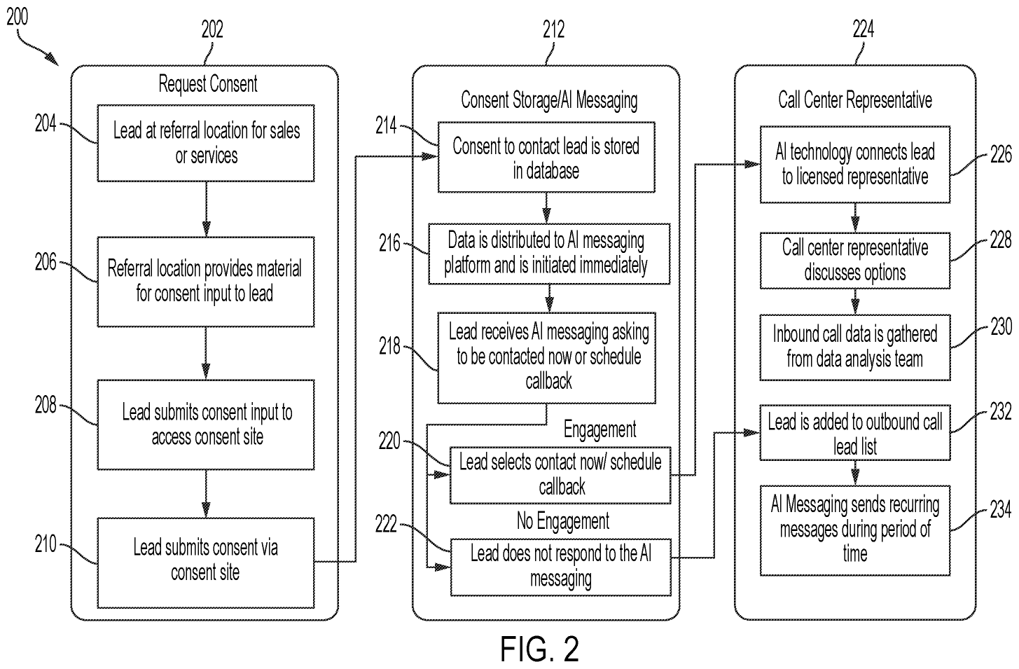

Referring to FIG. 1, a lead referral model 100 of the system 300 as an artificial intelligence (AI) system includes a method of generating a lead and sending automated AI messaging to the lead. In block 102, a consent input is offered to the lead. The system 300 may include one or more processors, one or more memory components communicatively coupled to the one or more processors, and machine readable instructions stored in the one or more memory components that cause the AI system to perform one or more processes and control schemes as descried herein (such as set forth in FIGS. 1 and 2) when executed by the one or more processors. In block 102, the consent input may be requested from the user through a consent request page of a digital selection form. The consent input may be indicative of consent by the user to be contacted regarding a product or service offer for a property through a consent request page of a digital selection form. By way of example, and not as a limitation, the lead may scan a code as a consent input such as a machine readable optical label, e.g., matrix barcode or “QR” code, that may be present at the referral location with a mobile device, such that upon scanning the code the mobile device is routed to a consent request page.

QR code utilization: The QR code may be a two-dimensional barcode used to encode and decode information. The QR code may be a graphical representation of data that may be scanned and interpreted by the mobile device. As mentioned hereinabove, the QR code may be located at the dealership as a referral location at which the lead is purchasing a product. The QR code may be linked to the particular referral location at which the customer is scanning the QR code. For example, the QR code for a particular car dealership may be unique to the particular car dealership, such that when the system 100 connects the lead with an agent, the agent will be able to recognize the referral location at which the customer scanned the QR code. Upon the customer scanning the QR code with the mobile device, a graphical user interface (GUI) of the mobile device may display a consent request page to the lead, i.e., a user associated with the mobile device. In addition to a consent request page, the GUI of the user device may be prompted to display further information to the user. Additionally or alternatively, scanning of the QR code may prompt another action by the user device, such as establishing a wireless connection, polling one or more sensors, requesting privacy or access permissions, and/or other suitable mobile device actions. In embodiments, the consent input may be requested from the user when the user is at a referral location associated with the property, and one or more rewards may be transferred to the referral location based on reception of the consent input from the user at the referral location. The consent input may be requested from the user when the user is at the referral location associated with the property via one or more of interactive communication or non-interactive communication with the mobile device of the user, as described in greater detail below. The interactive communication may include scan of a code or selection of a link via the mobile device to generate the consent input on a graphical user interface of the mobile device, and non-interactive communication may include a geospatial message sent to the mobile device based on sensing the user within a geospatial area of the referral location. In embodiments, the code may include a QR code, and/or the link is embedded on a digital platform associated with the referral location.

Alternatives to QR Codes: In some embodiments, the code may route the lead to the consent request page through alternative interactive communications with the mobile device other than a QR code. For example, a graphical user interface of the mobile device may be routed to the consent request page through a code and/or link embedded in a social media platform, a referral location website, and/or social media tag. In embodiments, the lead may click a link on the social media platform via a mobile device of the lead, which may automatically route the mobile device of the lead to the consent request page.

In other embodiments, the code may route the customer to the consent request page through a non-interactive communication with the mobile device that is not reliant on user initiation of an action such as scanning, clicking, and/or selection. The non-interactive communication may be a geospatial message, a Bluetooth beacon, or any other suitable non-interactive communication. Upon the mobile device of the lead entering into a prescribed geolocation such as a geospatial area of the referral location, the mobile device may receive the geospatial message, such that when the lead clicks on a link embedded in the geospatial message, the mobile device is directed to the consent request page. The prescribed geolocation may be inside of the referral location such as a dealership; in some embodiments, the prescribed geolocation includes the inside of the dealership along with an area surrounding the dealership. In other embodiments, the prescribed geolocation may include a retail establishment (including a parking lot), a train station, a bus stop, and/or portions of locations such as line management locations within theme parks, waiting rooms in doctors'/dentists' offices, and other suitable examples.

In block 104, at the consent request page, the lead may be prompted to provide consent via the digital selection form. In embodiments, the system 300 may receive the consent input from the user on the consent request page of the digital selection form. The consent request page may include information regarding terms of use the lead may accept by indicating consent on the GUI of the mobile device of the lead. For example, the terms of use could include a duration of time the system 300 is permitted to contact the customer. In some embodiments, the duration of time may be the maximum amount of time by law that the AI messaging system 100 is permitted to contact the customer. For example, the terms of use may include that the lead consent to being contacted for 30 days from a date of acceptance.

The consent request page may include a consent box (e.g., a check-box) consent form that may be completed through the GUI of the mobile device on the consent request page of the digital selection form. The consent box may be completed through the lead clicking on a box through the GUI; the consent request page may also include a digital signature box, or any other form in which the lead can indicate consent to the terms of use, for example a biometric signature such as a fingerprint scan. In embodiments, the consent input may be requested from the user through the consent box to be selected by the user or the digital signature box to be signed by the user on the consent request page of the digital selection form. In some embodiments, the customer may have an option to enter additional lead information on the consent request page 204. The additional lead information may be name, address, phone number, and/or any other suitable lead information that may be useful to the agent. When the lead has completed the consent request page and indicated approval, the system 100 is configured to generate the lead and further store and distribute data relating to the generated lead.

In block 106, upon receiving lead approval at the consent request page, lead data associated with the consenting lead may be stored and distributed to, as described in greater detail further below, systems and/or appropriate personnel to follow-up with the lead. In embodiments, responsive to receiving the consent input, the system 300 is configured to determine whether the user is associated with a lead profile. Responsive to determining the user is not associated with a lead profile for the user, a lead profile may be generated for the user comprising data associated with the user and the consent input. Responsive to determining the user is associated with a lead profile for the user, the lead profile may be updated with the consent input from the user.

As a non-limiting example, in block 108, the system 300 may then send a message via AI messaging to the lead requesting whether the lead would wish to be contacted to a representative to discuss the particular sales and/or services such as the product or service offer for the property. In embodiments, the system 300 is configured to send a message to a mobile device of the user, wherein the message presents the user with an option of being connected to an agent to discuss the product or service offer for the property. Upon approval by the lead and selection of the approval in the messaging, such as via clicking on a provided link in the messaging, the system 300 may be configured to route and connect the lead to the representative/agent. The representative may be a licensed agent able to then discuss insurance options with the lead. Thus, responsive to the user selecting the option of being connected to the agent, the user may be routed to the agent based on the lead profile.

Alternatively, in block 110, the lead may not select an option to connect with an agent and instead may be sent recurring AI messaging until expiration of a period of time, which may be, for example, a pre-determined duration of time such as a day range from about 10 days to 30 days. Thus, responsive to the user not selecting the option of being connected to the agent, the system 300 may be configured to send one or more further messages presenting the user with the option of being connected to the agent on a pre-determined schedule until (i) a pre-determined duration of time expires or (ii) the user selects the option of being connected to the agent within the pre-determined duration of time.

In an embodiment, the pre-determined duration of time may be 29 days. Thus, when the customer fails to indicate that the customer prefers to be routed to an agent, the system 300 may send a follow-up message after a predetermined time period on a pre-determined schedule to the lead, such as within 5 days. The AI messaging system 100 may continue to interact with the customer through follow-up messages through a series of messages 300 (FIG. 3) until a threshold time as a pre-determined duration of time, (such as 29 days), a threshold number of follow-up messages has been exceeded, and/or the lead selects the option of being connected to the agent.

Referring again to block 108, when the lead consents to the terms of use via the consent request page, the system 300 may send an AI generated message to the mobile device of the lead based on the received consent. The AI generated message may be an email, text message, voice message, social media message, or any other message capable of being received by the mobile device. In some embodiments, the message may be an interactive voice response system (IVR) contacting the lead through the mobile device.

In some embodiments, the AI generated message may be sent immediately after the lead consents to the terms of use through the consent request page. In other embodiments, the AI generated message may be sent minutes or hours after the lead consents to the terms of use. An amount of time between the lead consent and the message being sent may be dependent upon a lead preference indicated on the consent request page, a time of day, a product purchased by the lead, or a referral location in which the lead interacted with the code. For example, the lead may indicate that a preferred time of contact is between 8:00 a.m. to 10:00 a.m. Eastern Standard Time (EST). In embodiments, a preferred time of contact may be received from the user via the consent input, and the message may be sent to the user during the preferred time of contact. When such a preferred time is indicated by the lead, the system 300 may not send the message immediately within the preferred time window and may wait to send the message until the preferred time window occurs. In other embodiments, the message may be sent immediately after the lead purchases a product at the referral location, such as a vehicle. In embodiments, the message may be sent with a delay after the customer purchases a product, such as a home.

The initial AI generated message and the follow-up messages may be included in a series of messages when the customer does not respond to a first message as the initial AI generated message, as set forth in block 110, such that the system 300 is configured to send the follow-up messages to the lead. The series of messages may include a plurality of messages sent at varying times after the lead consents to the terms of use. The series of messages may include text messages and/or IVR messages sent to the mobile device of the lead at varying times after the lead consents to the terms of use. The first message may be sent immediately after the lead consents. Contents of the series of messages may be based on the particular code that was used, such as a QR code, to route the GUI of the mobile device to the consent request page. For example, the first message may congratulate the customer on a purchase of a new vehicle when the code is associated with a referral location that is a car dealership. When the code is associated with a mortgage broker, the first message may congratulate the customer on a purchase of a new home.

The series of messages may include an opt-out option. For example, the first message may present “Text NO to end.” Upon the lead messaging back “NO,” the system 300 may be configured to discontinue the series of messages to the mobile device of the lead. When the lead does not opt-out of the text messages, the series of messages may continue for a certain amount of time, such as for 5 days, 10 days, 30 days, a year, or indefinitely. In some embodiments, a length of time the series of messages may be sent may be limited by law of a jurisdiction.

Regaining consent through the series of messages: In embodiments where the length of time the series of messages may be sent is limited by law, the series of messages may include a final message, or a series of final messages, to regain consent of the customer, such as to restart the length of time in which the series of messages may be sent. For example, a restart message as a renewed consent input message may be the last in the series of messages. In embodiments, the system 300 may be configured to, (i) responsive to the user not selecting the option of being connected to the agent, request a renewed consent input from the user within a pre-determined time prior to expiration of the pre-determined duration of time, and (ii) receive the renewed consent input from the user, wherein the renewed consent input restarts the pre-determined duration of time the user may be contacted.

The renewed consent input message may notify the customer that the pre-determined duration of time for which the system 300 will continue to contact the customer has nearly ended. The renewed consent input message may be sent within a predetermined time prior to expiration of the pre-determined duration of time. The renewed consent input message may include a link to the consent request page (similar to what was displayed when the lead interacted with the code) for the lead to resubmit consent to be contacted. When the lead once again consents through the consent request page, the time pre-determined duration of time for the series of messages 300 is restarted and the lead may receive the first message again during the start of the new consent period. In some embodiments, the system 300 may recognize that the lead had previously consented, such that the system 300 may be configured to tailor the first message to conform to the lead who had previously consented and/or indicate a restart of the pre-determined duration of time.

The series of messages of the system 300 may be sent and controlled by an entity, such as an insurance company associated with a call center at which one or more licensed agents qualified to discuss sale and/or services with the lead are based. In other embodiments, a third-party not affiliated with the referral location or call center may control the system 300.

In embodiments, the series of messages may be generalized, such that all leads receive the same series of messages. In other embodiments, contents of the series of messages may be tailored to a particular region, as recognized through the code initially scanned by a lead at a referral location. For example, verbiage used in contents of the series of messages for a lead at a referral location in West Virginia will may be different than verbiage used in the series of messages for lead at a referral location in California. As mentioned hereinabove, the content of the series of messages may also differ depending on the type of referral location the code was associated with (a car dealership versus a mortgage broker). The content of the series of messages may also change depending on how the lead interacts with the system 300.

Referring again to block 108, when the lead indicates that the lead would like to speak to an agent via response to a message, the system 100 may be configured to connect the lead immediately to an agent. The agent may alternatively be provided with information to call the lead when the lead indicates an intent to speak to agent. In some embodiments, the lead may select a future time in which to be connected to the agent, such that immediate connection with the agent is not required.

In some embodiments, the lead may be linked to a lead profile within a database 314

(FIG. 3). The customer profile may include lead demographics associated with the lead. In embodiments, responsive to determining that the lead is not associated with a lead profile, a lead profile may be generated that includes data associated with the lead and the consent input. In contrast, responsive to determining that the lead is associated with a lead profile, the lead profile may be updated with the consent input from the lead. The lead demographics may include a caller location, a marital status, a customer age, status as a new or existing customer and/or lead, previous interactions with the lead, and/or any other suitable demographic that may be helpful in assisting the agent to complete a sale with the lead. The lead may be linked to the lead profile within the database 314 through a common phone number, name, and/or address. In embodiments, content of any of the message and the one or more further messages to the user may be tailored based on at least one of the following: a user location, a product the user has recently purchased, a referral location at which the user navigated to the consent request page, a user age, a user marital status, or combinations thereof.

The lead may also be linked to a user profile on an entity mobile application, such as when the entity is an insurance company. In embodiments, the user profile for the user within an entity database may be linked to the lead profile through a common phone number, name, or address of the user. The lead profile of the user may be linked to a user profile associated with an application, an external database, or both, for an entity, wherein the application is at least one of a web or mobile-based application, and the agent may be granted access to the user profile to view information about the user stored within the user profile. The entity may be an insurance company. The entity mobile application may be a web or a mobile-based application. The user profile may include the lead demographics, such that the lead demographics are linked with the lead profile within the database 314. The lead may also be linked to an external database 314, such that the agent may gain information about the lead that is not in an internal database 314 or the user profile. In some embodiments, the lead demographics in the internal database 314 associated with an entity at which the agent works are compared to lead information in the external database 314 not associated with the entity. When an agent is connected to a user/lead, the agent may be granted access to the user profile to view information about the user stored within the user profile.

Lead information stored on the database 314 may be stored for a month, six months, a year, or indefinitely. The lead information stored in the database 314 may be integrated with, or kept separate from the lead demographics in either the lead profile or the user profile. Agents/representatives may also each have a corresponding agent profile, which contains metrics as to how the agent performs when handling certain types of leads/users. The lead may be routed to the agent based on the demographics associated with the lead and metrics associated with the agent.

When the lead has consented to the terms of use through the consent request page, the system 100 may generate and store the lead information. The lead may be assigned a lead score based on an amount of one or more interactions between the lead and the system 100 over a period of time and timing of the one or more interactions. The one or more interactions and the lead score may be indicative of a response by the lead to the message or the one or more further messages. Speedier responses may be assigned a higher lead score than a lengthier interaction and no interaction may be assigned a lower score that at least one interaction by the lead. Thus, in embodiments, the system 300 may be configured to assign a lead score to the lead profile of the user. The lead score may be based on an amount of one or more interactions between the user and the AI system over a period of time and timing of the one or more interactions. The one or more interactions may be indicative of a response by the user to the message or the one or more further messages. A speedier interaction may be assigned a higher lead score than a lengthier interaction, and no interaction may be assigned a lower score than at least one interaction by the user

The lead may also be ranked on a lead scale as a hot lead, a cold lead, or ranked somewhere between, such as based on the score. The hot lead may be a lead that has recently been generated. For example, the hot lead may be a lead in which the lead has interacted with the QR code at a referral location, consented to the terms of use through the consent request page, and responded to the AI messaging within a span of a short period of time, such as thirty minutes. The cold lead may be a lead that was not recently generated; the cold lead may be a lead in which the customer interacted with the QR code at the referral location and consented to the terms of use through the consent request page and has yet to respond to the AI messaging after an extended period of time (such as twenty days).

The lead scale may include a numbering scale, such that hot leads are ranked higher and cold leads are ranked lower. For example, the lead scale may be from 1-100. A first lead may be considered a hot lead and ranked as a 90/100. Five days later, the first lead may then be ranked a 65/100. Twenty-five days later, the first lead may now be considered a cold lead and ranked as a 15/100. Whether a lead is a hot lead or a cold lead may be determined by a ranking threshold; for example, leads with a rank over 80/100 may be considered a hot lead, while leads with a rank below 20/100 may be considered a cold lead.

In embodiments, the generated leads may be sold. For example, the vendor may wish to sell the leads to another vendor. The vendor may also wish to buy leads from another vendor. A price of the leads may depend on the rank of the lead. A hot lead ranked highly may sell for more than a cold lead ranked lowly.

Incentivizing referral locations based on amount of leads, location, and type of referral: An entity receiving the lead may incentivize or offer one or more rewards, e.g., pay, offer discounts to, etc., the referral location at which the lead interacted with the code and gave consent to be a lead and be messaged. The consent input may be requested while the user is at the referral location, such that the referral location may be associated with the consent input from the user. The entity may transfer one or more rewards to the referral location based on the number of leads obtained through the code associated with the referral location or the number of leads where consent input was received while the lead was located at the referral location. The referral fee may be a different amount of money depending on the amount of leads generated, region of the referral location, and/or the type of lead.

The entity may pay a referral location such as a dealership the referral fee for every lead the vendor obtains through the code associated with the referral location. For example, the entity may pay the referral location a referral fee of $50 for every lead the referral location generates. In embodiments, the amount of the referral fee may differ depending on the type of lead. For example, the referral fee may be $100 for a home insurance referral, while the referral fee may be $50 for a vehicle insurance referral. In further embodiments, the referral fee may also differ depending on the particular location or the particular referral location (such as a dealership) at which the lead is interacting with an associated code. For example, the referral fee may be $200 for a home insurance referral in New York, and the referral fee may be $100 for a home insurance referral fee in Kentucky.

A performance of a referral location in generating leads may be recorded. The performance may include an amount of lead referrals, the type of referrals, and/or any other suitable performance metric. Performance may be scored, ranked, and compared across performance of other referral locations.

Referring to FIG. 2, a process 200 sets forth expanded features of the lead referral model 100 of FIG. 1. In block 202, corresponding to block 102 of FIG. 1, consent is requested from the potential lead. For example, in sub-block 204, the potential lead is at the referral location for a reason, such as to purchase a car at a dealership as the referral location. The potential lead may wish to purchase insurance for the car, which the dealership is unable and not licensed to offer. In sub-block 206, the referral location may provide the potential lead with materials for a consent input to the potential lead. For example, the potential lead may be provided with a code, such as a QR code associated with the referral location, to scan via a mobile device to be sent to a consent request page. In sub-block 208, the potential lead submits such consent input to access the consent site (such as a digital consent page). In sub-block 210, the potential lead submits consent via the consent site to become a generated lead and be contacted.

In block 212, corresponding to block 106 of FIG. 1, a lead that has consented is stored as a consenting lead the database 314. In sub-block 214, the consent submitted by the potential lead to be contacted, such as the approved consent request page and timestamp of approval and consent, is stored in the database 314. In sub-block 216, data associated with the generated lead stored in the database 314 is distributed to an AI messaging platform, and AI messaging to the lead is initiated, such as immediately upon receipt of the data. In sub-block 218, the lead receives the AI messaging requesting whether the lead wishes to be connected with a call center representative to discuss options regarding goods and services automatically and immediately upon selection of the prompt to connect or whether the lead wishes to be scheduled for a callback by the call center representative/agent. When the lead selects an option of being connected to the agent at a later date and time, a time may be scheduled to route the lead to the agent for a callback based on the later date and time that the user has selected.

In sub-block 220, corresponding to block 108 of FIG. 1, should the lead engage with the AI messaging platform, the lead may select an option to be contacted immediately or scheduled for a callback. Thus, the message may present the user with an option of being connected to the agent at a later date and time. The system 300 may further be configured to, responsive to the user selecting the option of being connected to the agent at the later date and time, schedule a time to route the user to the agent for a callback based on the later date and time. In block 224, a call center representative may be contacted to connect with the lead based on lead consent for contact by the call center representative. Based on the selection of the lead in sub-block 220, the AI technology associated with the AI messaging platform is configured to connect the lead to a licensed representative/agent. The lead may be routed to the agent based on the lead profile and the agent profile of the agent. In sub-block 228, the licensed representative discusses options with the lead, such as during a voice call session in which options regarding goods and services associated with a product may be discussed (such as insurance options for a vehicle the lead may have purchased as the referral location). In sub-block 230, inbound call data from the voice call session may be gathered by a data analysis team for tracking and metrics, such as to generate bind (e.g., likelihood of a sale) metrics for the agent profile based on inbound call data while the licensed representative discussing options with the lead. In embodiments, responsive to the user selecting the option of being connected to the agent, the system 300 may be configured to route the user to the agent based on the lead profile and an agent profile of the agent to initiate a voice call session, gather inbound call data from the voice call session between the user and the agent, and/or generate one or more bind metrics for the agent profile of the agent based on the inbound call data. In embodiments, the system 300 may be configured to route the user to the agent based on one or more demographics associated with the user and one or more metrics associated with the agent.

In block 222, corresponding to block 110 of FIG. 1, should the lead not engage with the AI messaging platform, the AI messaging platform does not receive a response from the lead. In sub-block 232, the lead that is not responding is added to an outbound call lead list. In sub-block 234, the AI messaging platform sends recurring messages to the lead (e.g., similar to sub-block 218) during a pre-determined duration of time, such as until an expiration of the time as described herein or until the lead responds in sub-block 220.

Referring to FIG. 3, the system 300 for implementing a computer and software-based method, such as via those of FIGS. 1-2, to generate leads and send automated AI messaging to the generated leads as described herein is shown. The system 300 may be implemented along with using a graphical user interface (GUI) that is accessible at a user workstation (e.g., a mobile device associated with the lead/potential lead, such as a computer 324), for example. The user workstation may be a smart mobile device, which may be a smartphone, a tablet, or a like portable handheld smart device. As a non-limiting example, the smart mobile device may be a smartphone or a tablet. The smart mobile device includes a camera, a processor, a memory communicatively coupled to the processor, and machine readable instructions stored in the memory. The machine readable instructions may cause the system 300 to, when executed by the processor, launch and operate a software application tool on the smart mobile device. The machine readable instructions may cause the system 300 to, when executed by the processor, use the functionality provided by the software application tool to follow one or more control schemes as set forth in the one or more processes described herein.

The system 300 includes machine readable instructions stored in non-transitory memory that cause the system 300 to perform one or more of instructions when executed by the one or more processors, as described in greater detail below. The system 300 includes a communication path 302, one or more processors 304, a memory component 306, a lead generation component 312, a storage or database 314 that may include a product image database, an artificial intelligence component 316, a network interface hardware 318, a server 320, a network 322, and at least one computer 324. The various components of the system 300 and the interaction thereof will be described in detail below.

In some embodiments, the system 300 is implemented using a wide area network (WAN) or network 322, such as an intranet or the Internet, or other wired or wireless communication network that may include a cloud computing-based network configuration. The computer 324 may include digital systems and other devices permitting connection to and navigation of the network, such as the smart mobile device. Other system 300 variations allowing for communication between various geographically diverse components are possible. The lines depicted in FIG. 3 indicate communication rather than physical connections between the various components.

As noted above, the system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data. The processor 304 may process the input signals received from the system modules and/or extract information from such signals.

As noted above, the system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the system 300 may include the processor 304 communicatively coupled to the memory component 306 that stores instructions that, when executed by the processor 304, cause the processor to perform one or more functions as described herein.

Still referring to FIG. 3, as noted above, the system 300 comprises the display such as a GUI on a screen of the computer 324 for providing visual output such as, for example, information, graphical reports, messages, or a combination thereof. The computer 324 may include one or more computing devices across platforms, or may be communicatively coupled to devices across platforms, such as smart mobile devices including smartphones, tablets, laptops, and/or the like. The display on the screen of the computer 324 is coupled to the communication path 302 and communicatively coupled to the processor 304. Accordingly, the communication path 302 communicatively couples the display to other modules of the system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the system 300 is illustrated as a single, integrated system in FIG. 3, in other embodiments, the systems can be independent systems.

The system 300 comprises the lead generation component 312 to automate lead generation of a lead based on receiving consent as described herein from a potential lead via a code associated with a referral location and the artificial intelligence component 316 to train and provide machine learning capabilities to a neural network to aid with automated lead generation and messaging as described herein. The lead generation component 312 and the artificial intelligence component 316 are coupled to the communication path 302 and communicatively coupled to the processor 304. The processor 304 may process the input signals received from the system modules and/or extract information from such signals.

Data stored and manipulated in the system 300 as described herein is utilized by the artificial intelligence component 316, which is able to leverage a cloud computing-based network configuration such as the cloud to apply Machine Learning and Artificial Intelligence. This machine learning application may create models that can be applied by the system 300, to make it more efficient and intelligent in execution. As an example and not a limitation, the artificial intelligence component 316 may include components selected from the group consisting of an artificial intelligence engine, Bayesian inference engine, and a decision-making engine, and may have an adaptive learning engine further comprising a deep neural network learning engine.

The system 300 includes the network interface hardware 318 for communicatively coupling the system 300 with a computer network such as network 322. The network interface hardware 318 is coupled to the communication path 302 such that the communication path 302 communicatively couples the network interface hardware 218 to other modules of the system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computer 324 can be provided from the computer 324 to the system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, the cloud 323, satellite networks, or the like. Accordingly, the network 322 can be utilized as a wireless access point by the computer 324 to access one or more servers (e.g., a server 320). The server 320 and any additional servers such as a cloud server generally include processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Aspects Listing:

Aspect 1. An Artificial Intelligence (AI) system including: one or more processors, one or more memory components communicatively coupled to the one or more processors, and machine readable instructions stored in the one or more memory components that cause the AI system to perform at least the following when executed by the one or more processors: request a consent input from a user indicative of consent by the user to be contacted regarding a product or service offer for a property through a consent request page of a digital selection form, receive the consent input from the user on the consent request page of the digital selection form, responsive to receiving the consent input, determine whether the user is associated with a lead profile, responsive to determining the user is not associated with a lead profile for the user, generate a lead profile for the user including data associated with the user and the consent input, send a message to a mobile device of the user, wherein the message presents the user with an option of being connected to an agent to discuss the product or service offer for the property, responsive to the user selecting the option of being connected to the agent, route the user to the agent based on the lead profile, and responsive to the user not selecting the option of being connected to the agent, send one or more further messages presenting the user with the option of being connected to the agent on a pre-determined schedule until (i) a pre-determined duration of time expires or (ii) the user selects the option of being connected to the agent within the pre-determined duration of time.

Aspect 2. The AI system of Aspect 1, wherein the machine readable instructions further cause the AI system to perform at least the following when executed by the one or more processors: responsive to determining the user is associated with a lead profile for the user, update the lead profile with the consent input from the user.

Aspect 3. The AI system of Aspect 1 or Aspect 2, wherein the machine readable instructions further cause the AI system to perform at least the following when executed by the one or more processors: responsive to the user not selecting the option of being connected to the agent, request a renewed consent input from the user within a pre-determined time prior to expiration of the duration of time, and receive the renewed consent input from the user, wherein the renewed consent input restarts the duration of time the user may be contacted.

Aspect 4. The AI system of any of Aspect 1 to Aspect 3, wherein the machine readable instructions further cause the AI system to perform at least the following when executed by the one or more processors: responsive to the user selecting the option of being connected to the agent, route the user to the agent based on the lead profile and an agent profile of the agent to initiate a voice call session, gather inbound call data from the voice call session between the user and the agent, and generate one or more bind metrics for the agent profile of the agent based on the inbound call data.

Aspect 5. The AI system of any of Aspect 1 to Aspect 4, wherein the message presents the user with an option of being connected to the agent at a later date and time, and wherein the machine readable instructions further cause the AI system to perform at least the following when executed by the one or more processors: responsive to the user selecting the option of being connected to the agent at the later date and time, schedule a time to route the user to the agent for a callback based on the later date and time.

Aspect 6. The AI system of any of Aspect 1 to Aspect 5, wherein the machine readable instructions further cause the AI system to perform at least the following when executed by the one or more processors: receive a preferred time of contact from the user via the consent input, and send the message to the user during the preferred time of contact.

Aspect 7. The AI system of any of Aspect 1 to Aspect 6, wherein the machine readable instructions further cause the AI system to perform at least the following when executed by the one or more processors: tailor content of the message and the one or more further messages to the user based on at least one of the following: a user location, a product the user has recently purchased, a referral location at which the user navigated to the consent request page, a user age, a user marital status, or combinations thereof.

Aspect 8. The AI system of any of Aspect 1 to Aspect 7, wherein the machine readable instructions further cause the AI system to perform at least the following when executed by the one or more processors: request the consent input from the user when the user is at a referral location associated with the property, and transfer one or more rewards to the referral location based on reception of the consent input from the user at the referral location.

Aspect 9. The AI system of Aspect 8, wherein the machine readable instructions further cause the AI system to perform at least the following when executed by the one or more processors: request the consent input from the user when the user is at the referral location associated with the property via one or more of interactive communication or non-interactive communication with the mobile device of the user.

Aspect 10. The AI system of Aspect 9, wherein interactive communication includes scan of a code or selection of a link via the mobile device to generate the consent input on a graphical user interface of the mobile device, and wherein non-interactive communication includes a geospatial message sent to the mobile device based on sensing the user within a geospatial area of the referral location.

Aspect 11. The AI system of Aspect 10, wherein the code includes a QR code, and wherein the link is embedded on a digital platform associated with the referral location.

Aspect 12. The AI system of any of Aspect 1 to Aspect 11, wherein a user profile for the user within an entity database is linked to the lead profile through a common phone number, name, or address of the user.

Aspect 13. The AI system of any of Aspect 1 to Aspect 12, wherein the machine readable instructions further cause the AI messaging system to perform at least the following when executed by the one or more processors: link the lead profile of the user to a user profile associated with an application, an external database, or both, for an entity, wherein the application is at least one of a web or mobile-based application, and grant the agent access to the user profile to view information about the user stored within the user profile.

Aspect 14. The AI system of Aspect 13, wherein the entity is an insurance company.

Aspect 15. The AI system of any of Aspect 1 to Aspect 14, wherein machine readable instructions further cause the AI messaging system to perform at least the following when executed by the one or more processors: assign a lead score to lead profile of the user, wherein the lead score is based on an amount of one or more interactions between the user and the AI system over a period of time and timing of the one or more interactions, wherein the one or more interactions are indicative of a response by the user to the message or the one or more further messages, wherein a speedier interaction is assigned a higher lead score than a lengthier interaction, and wherein no interaction is assigned a lower score that at least one interaction by the user.

Aspect 16. The AI system of any of Aspect 1 to Aspect 15, wherein machine readable instructions further cause the AI messaging system to perform at least the following when executed by the one or more processors: route the user to the agent based on one or more demographics associated with the user and one or more metrics associated with the agent.

Aspect 17. The AI system of any of Aspect 1 to Aspect 16, wherein the machine readable instructions further cause the AI messaging system to perform at least the following when executed by the one or more processors: request the consent input from the user through a consent box to be selected by the user or a digital signature box to be signed by the user on the consent request page of the digital selection form.

Aspect 18. An artificially intelligent computer implemented method including requesting a consent input from a user indicative of consent by the user to be contacted regarding a product or service offer for a property through a consent request page of a digital selection form, receiving the consent input from the user on the consent request page of the digital selection form, responsive to receiving the consent input, determining whether the user is associated with a lead profile, responsive to determining the user is not associated with a lead profile for the user, generating a lead profile for the user including data associated with the user and the consent input, sending a message to a mobile device of the user, wherein the message presents the user with an option of being connected to an agent to discuss the product or service offer for the property, responsive to the user selecting the option of being connected to the agent, routing the user to the agent based on the lead profile, and responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.

Aspect 19. The method of Aspect 19, further including: responsive to determining the user is associated with a lead profile for the user, updating the lead profile with the consent input from the user.

Aspect 20. An artificially intelligent computer implemented method includes requesting a consent input from a user when the user is at a referral location associated with a property, the consent input indicative of consent by the user to be contacted regarding a product or service offer for the property through a consent request page of a digital selection form displayed on a mobile device of the user, via one or more of interactive communication or non-interactive communication with the mobile device of the user, receiving the consent input from the user on the consent request page of the digital selection form, responsive to receiving the consent input, determining whether the user is associated with a lead profile, responsive to determining the user is not associated with a lead profile for the user, generating a lead profile for the user including data associated with the user and the consent input, sending a message to a mobile device of the user, wherein the message presents the user with an option of being connected to an agent to discuss the product or service offer for the property, responsive to the user selecting the option of being connected to the agent, routing the user to the agent based on the lead profile, and responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.

1. An Artificial Intelligence (AI) system comprising:
one or more processors;
one or more memory components communicatively coupled to the one or more processors; and
machine readable instructions stored in the one or more memory components that cause the AI system to perform at least the following when executed by the one or more processors:
request a consent input from a user indicative of consent by the user to be contacted regarding a product or service offer for a property through a consent request page of a digital selection form;
receive the consent input from the user on the consent request page of the digital selection form;
responsive to receiving the consent input, determine whether the user is associated with a lead profile;
responsive to determining the user is not associated with a lead profile for the user, generate a lead profile for the user comprising data associated with the user and the consent input;
send a message to a mobile device of the user, wherein the message presents the user with an option of being connected to an agent to discuss the product or service offer for the property;
responsive to the user selecting the option of being connected to the agent, route the user to the agent based on the lead profile; and
responsive to the user not selecting the option of being connected to the agent, send one or more further messages presenting the user with the option of being connected to the agent on a pre-determined schedule until (i) a pre-determined duration of time expires or (ii) the user selects the option of being connected to the agent within the pre-determined duration of time.

2. The AI system of claim 1, wherein the machine readable instructions further cause the AI system to perform at least the following when executed by the one or more processors:
responsive to determining the user is associated with a lead profile for the user, update the lead profile with the consent input from the user.

3. The AI system of claim 1, wherein the machine readable instructions further cause the AI system to perform at least the following when executed by the one or more processors:
responsive to the user not selecting the option of being connected to the agent, request a renewed consent input from the user within a pre-determined time prior to expiration of the pre-determined duration of time; and
receive the renewed consent input from the user, wherein the renewed consent input restarts the pre-determined duration of time the user may be contacted.

4. The AI system of claim 1, wherein the machine readable instructions further cause the AI system to perform at least the following when executed by the one or more processors:
responsive to the user selecting the option of being connected to the agent, route the user to the agent based on the lead profile and an agent profile of the agent to initiate a voice call session;
gather inbound call data from the voice call session between the user and the agent; and
generate one or more bind metrics for the agent profile of the agent based on the inbound call data.

5. The AI system of claim 1, wherein the message presents the user with an option of being connected to the agent at a later date and time, and wherein the machine readable instructions further cause the AI system to perform at least the following when executed by the one or more processors:
responsive to the user selecting the option of being connected to the agent at the later date and time, schedule a time to route the user to the agent for a callback based on the later date and time.

6. The AI system of claim 1, wherein the machine readable instructions further cause the AI system to perform at least the following when executed by the one or more processors:
receive a preferred time of contact from the user via the consent input; and
send the message to the user during the preferred time of contact.

7. The AI system of claim 1, wherein the machine readable instructions further cause the AI system to perform at least the following when executed by the one or more processors:
tailor content of the message and the one or more further messages to the user based on at least one of the following:
a user location;
a product the user has recently purchased;
a referral location at which the user navigated to the consent request page;
a user age;
a user marital status; or
combinations thereof.

8. The AI system of claim 1, wherein the machine readable instructions further cause the AI system to perform at least the following when executed by the one or more processors:
request the consent input from the user when the user is at a referral location associated with the property; and
transfer one or more rewards to the referral location based on reception of the consent input from the user at the referral location.

9. The AI system of claim 8, wherein the machine readable instructions further cause the AI system to perform at least the following when executed by the one or more processors:
request the consent input from the user when the user is at the referral location associated with the property via one or more of interactive communication or non-interactive communication with the mobile device of the user.

10. The AI system of claim 9, wherein interactive communication comprises scan of a code or selection of a link via the mobile device to generate the consent input on a graphical user interface of the mobile device, and wherein non-interactive communication comprises a geospatial message sent to the mobile device based on sensing the user within a geospatial area of the referral location.

11. The AI system of claim 10, wherein the code comprises a QR code, and wherein the link is embedded on a digital platform associated with the referral location.

12. The AI system of claim 1, wherein a user profile for the user within an entity database is linked to the lead profile through a common phone number, name, or address of the user.

13. The AI system of claim 1, wherein the machine readable instructions further cause the AI messaging system to perform at least the following when executed by the one or more processors:
link the lead profile of the user to a user profile associated with an application, an external database, or both, for an entity, wherein the application is at least one of a web or mobile-based application; and
grant the agent access to the user profile to view information about the user stored within the user profile.

14. The AI system of claim 13, wherein the entity is an insurance company.

15. The AI system of claim 1, wherein machine readable instructions further cause the AI messaging system to perform at least the following when executed by the one or more processors:
assign a lead score to lead profile of the user, wherein the lead score is based on an amount of one or more interactions between the user and the AI system over a period of time and timing of the one or more interactions, wherein the one or more interactions are indicative of a response by the user to the message or the one or more further messages, wherein a speedier interaction is assigned a higher lead score than a lengthier interaction, and wherein no interaction is assigned a lower score than at least one interaction by the user.

16. The AI system of claim 1, wherein machine readable instructions further cause the AI messaging system to perform at least the following when executed by the one or more processors:
route the user to the agent based on one or more demographics associated with the user and one or more metrics associated with the agent.

17. The AI system of claim 1, wherein the machine readable instructions further cause the AI messaging system to perform at least the following when executed by the one or more processors:
request the consent input from the user through a consent box to be selected by the user or a digital signature box to be signed by the user on the consent request page of the digital selection form.

18. An artificially intelligent computer implemented method, the method comprising:
requesting a consent input from a user indicative of consent by the user to be contacted regarding a product or service offer for a property through a consent request page of a digital selection form;
receiving the consent input from the user on the consent request page of the digital selection form;
responsive to receiving the consent input, determining whether the user is associated with a lead profile;
responsive to determining the user is not associated with a lead profile for the user, generating a lead profile for the user comprising data associated with the user and the consent input;
sending a message to a mobile device of the user, wherein the message presents the user with an option of being connected to an agent to discuss the product or service offer for the property;
responsive to the user selecting the option of being connected to the agent, routing the user to the agent based on the lead profile; and
responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.

19. The method of claim 18, further comprising:
responsive to determining the user is associated with a lead profile for the user, updating the lead profile with the consent input from the user.

20. An artificially intelligent computer implemented method, the method comprising:
requesting a consent input from a user when the user is at a referral location associated with a property, the consent input indicative of consent by the user to be contacted regarding a product or service offer for the property through a consent request page of a digital selection form displayed on a mobile device of the user, via one or more of interactive communication or non-interactive communication with the mobile device of the user;
receiving the consent input from the user on the consent request page of the digital selection form;
responsive to receiving the consent input, determining whether the user is associated with a lead profile;
responsive to determining the user is not associated with a lead profile for the user, generating a lead profile for the user comprising data associated with the user and the consent input;
sending a message to a mobile device of the user, wherein the message presents the user with an option of being connected to an agent to discuss the product or service offer for the property;
responsive to the user selecting the option of being connected to the agent, routing the user to the agent based on the lead profile; and
responsive to the user not selecting the option of being connected to the agent, sending one or more further messages presenting the user with the option of being connected to the agent on a pre-determined schedule until (i) a pre-determined duration of time expires or (ii) the user selects the option of being connected to the agent within the pre-determined duration of time.
